(19) United States
(12) Patent Application Publication
(10) Pub. No.: US 2017/0140278 A1
(43) Pub. Date: May 18, 2017

(54) USING MACHINE LEARNING TO PREDICT BIG DATA ENVIRONMENT PERFORMANCE

(71) Applicant: CA, Inc., New York, NY (US)

(72) Inventors: Smrati Gupta, Barcelona (ES); Jacek Dominiak, Barcelona (ES); Sanjai Marimadaiah, Fremont, CA (US)

(73) Assignee: CA, Inc., New York, NY (US)

(21) Appl. No.: 14/944,969

(22) Filed: Nov. 18, 2015

(51) Int. Cl. G06N 5/04; G06N 99/00

(52) U.S. Cl. CPC G06N 5/04; G06N 99/005

(57) ABSTRACT

A method includes performing operations as follows on a processor: receiving a big data dataset comprising new active data, receiving a request to predict a level of performance with respect to a performance parameter of a data processing system in analyzing the new active data, selecting a machine learning algorithm from a plurality of machine learning algorithms based on the performance parameter to obtain a selected machine learning algorithm, selecting a group of historical metadata from a plurality of groups of historical metadata of datasets that have previously been analyzed using the data processing system to provide a selected group of historical metadata, applying the selected machine learning algorithm to the selected group of historical metadata to generate a model of the selected group of historical metadata, obtaining metadata of the new active data, applying the model to the metadata of the new active data to generate a prediction of the level of performance with respect to the performance parameter; and configuring the data processing system for analyzing the new active data based on the prediction.

### BACKGROUND

The present disclosure relates to computing systems, and, in particular, to methods, systems, and computer program products for predicting the performance of a data processing system in performing an analysis of a big data dataset.

Big data is a term or catch-phrase that is often used to describe data sets of structured and/or unstructured data that are so large or complex that they are often difficult to process using traditional data processing applications. Data sets tend to grow to such large sizes because the data are increasingly being gathered by cheap and numerous information generating devices. Big data can be characterized by 3Vs: the extreme volume of data, the variety of types of data, and the velocity at which the data is processed. Although big data doesn't refer to any specific quantity or amount of data, the term is often used in referring to petabytes or exabytes of data. The big data datasets can be processed using various analytic and algorithmic tools to reveal meaningful information that may have applications in a variety of different disciplines including government, manufacturing, health care, retail, real estate, finance, and scientific research.

### SUMMARY

In some embodiments of the inventive subject matter, a method comprises performing operations as follows on a processor: receiving a big data dataset comprising new active data; receiving a request to predict a level of performance with respect to a performance parameter of a data processing system in analyzing the new active data; selecting a machine learning algorithm from a plurality of machine learning algorithms based on the performance parameter to obtain a selected machine learning algorithm; selecting a group of historical metadata from a plurality of groups of historical metadata of datasets that have previously been analyzed using the data processing system to provide a selected group of historical metadata; applying the selected machine learning algorithm to the selected group of historical metadata to generate a model of the selected group of historical metadata; obtaining metadata of the new active data; applying the model to the metadata of the new active data to generate a prediction of the level of performance with respect to the performance parameter; and configuring the data processing system for analyzing the new active data based on the prediction.

In other embodiments of the inventive subject matter, a system comprises a processor and a memory coupled to the processor, which comprises computer readable program code embodied in the memory that when executed by the processor causes the processor to perform operations comprising: receiving a big data dataset comprising new active data; receiving a request to predict a level of performance with respect to a performance parameter of a data processing system in analyzing the new active data; selecting a machine learning algorithm from a plurality of machine learning algorithms based on the performance parameter to obtain a selected machine learning algorithm; selecting a group of historical metadata from a plurality of groups of historical metadata of datasets that have previously been analyzed using the data processing system to provide a selected group of historical metadata; applying the selected machine learning algorithm to the selected group of historical metadata to generate a model of the selected group of historical metadata; obtaining metadata of the new active data; applying the model to the metadata of the new active data to generate a prediction of the level of performance with respect to the performance parameter; and configuring the data processing system for analyzing the new active data based on the prediction.

In still other embodiments of the inventive subject matter, a computer program product comprises a tangible computer readable storage medium comprising computer readable program code embodied in the medium that when executed by a processor causes the processor to perform operations comprising: receiving a big data dataset comprising new active data; receiving a request to predict a level of performance with respect to a performance parameter of a data processing system in analyzing the new active data; selecting a machine learning algorithm from a plurality of machine learning algorithms based on the performance parameter to obtain a selected machine learning algorithm; selecting a group of historical metadata from a plurality of groups of historical metadata of datasets that have previously been analyzed using the data processing system to provide a selected group of historical metadata; applying the selected machine learning algorithm to the selected group of historical metadata to generate a model of the selected group of historical metadata; obtaining metadata of the new active data; applying the model to the metadata of the new active data to generate a prediction of the level of performance with respect to the performance parameter; and configuring the data processing system for analyzing the new active data based on the prediction.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a decision support system for configuring a data processing system for analyzing a big data dataset in accordance with some embodiments of the inventive subject matter;

FIG. 2 illustrates a data processing system that may be used to implement the big data environment advisor system of FIG. 1 in accordance with some embodiments of the inventive subject matter;

FIG. 3 is a block diagram that illustrates a software/hardware architecture for configuring a data processing system for analyzing a big data dataset in accordance with some embodiments of the present inventive subject matter;

FIG. 4 is a block diagram that illustrates functional relationships between the modules of FIG. 3; and

FIG. 5 is a flowchart that illustrates operations for configuring a data processing system for analyzing a big data dataset in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but is not limited to, a hardware element, firmware component, and/or software component. A data processing system may be configured with one or more data processing facilities.

Some embodiments of the inventive subject matter stem from a realization that big data datasets may differ in a variety of ways, including the traditional 3V characteristics of volume, variety, and velocity as well as other characteristics, such as variability (e.g., data inconsistency), veracity (quality of the data), and complexity. As a result, a data processing environment used to analyze or process one big data dataset may be less suitable for analyzing or processing a different big data dataset. Some embodiments of the inventive subject matter may provide the operators of a big data analysis data processing system a prediction of how well the data processing may perform in analyzing a big data dataset with respect to one or more performance parameters. The performance parameters may include, but are not limited to, time of execution for performing an analysis, a probability of success (e.g., determining a pattern in the big data dataset), the amount of processor resources used in performing the analysis, and the amount of memory resources used in performing the analysis.

Some embodiments of the inventive subject matter may provide a Decision Support System (DSS) for generating the prediction of how well a data processing system may perform in analyzing a given big data dataset, which can then be used to configure the data processing system for improved performance. The decision support system may generate the performance prediction in response to a new prediction request for a new big data dataset based on historical job data corresponding to previous big data datasets that have been analyzed and based on various machine learning algorithms that have been used in predicting the performance of analyzing previous big data datasets, which have had their accuracy evaluated based on actual results.

Although described herein with respect to evaluating the performance of a data processing system for analyzing big data datasets, it will be understood that embodiments of the present inventive subject matter are not limited thereto and may be applicable to evaluating the performance of data processing systems generally with respect to a variety of different tasks.

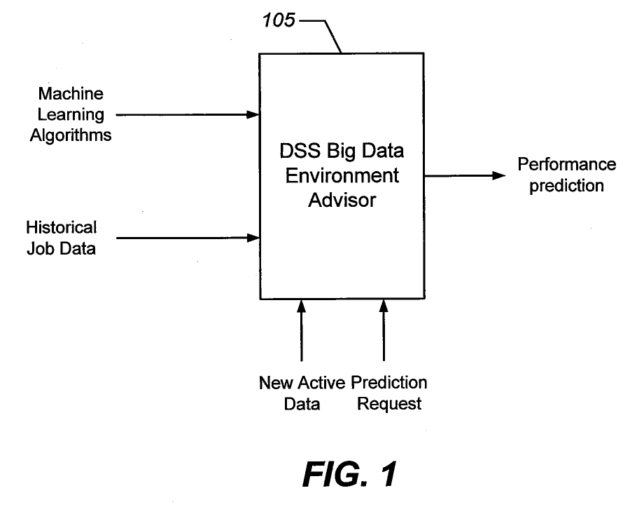

FIG. 1 is a block diagram of a DSS for configuring a data processing system for analyzing a big data dataset in accordance with some embodiments of the inventive subject matter. A DSS big data environment advisor data processing system 105 is configured to receive a big data dataset comprising new active data along with a prediction request to predict the performance of a data processing system with respect to one or more performance parameters in analyzing the new active data. The big data environment advisor data processing system 105 may generate the performance prediction based on historical job metadata corresponding to previous big data datasets that have been analyzed and based on various machine learning algorithms that have been used in predicting the performance of analyzing previous big data datasets, which have had their accuracy evaluated based on actual results.

The performance prediction generated by the DSS big data environment advisor 105 may be used as a basis for configuring a data processing system to analyze the new active data in the big data dataset. Configuring a data processing system may involve various operations including, but not limited to, adjusting the processing, memory, networking, and other resources associated with the data processing system. Configuring the data processing system may also involve scheduling which jobs are run at certain times and/or re-assigning jobs between the data processing system and other data processing systems. In addition, the particular analytic tools and applications that are used to process the big data dataset may be selected enhance efficiency.

Although FIG. 1 illustrates a decision support system for configuring a data processing system for analyzing a big data dataset in accordance with some embodiments of the inventive subject matter it will be understood that embodiments of the present invention are not limited to such configurations, but are intended to encompass any configuration capable of carrying out the operations described herein.

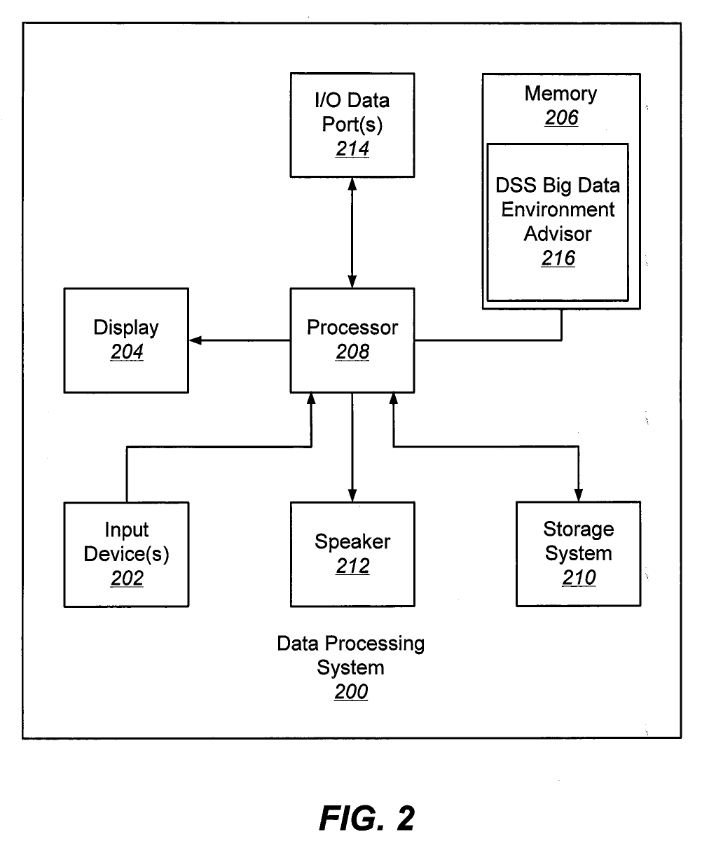

Referring now to FIG. 2, a data processing system 200 that may be used to implement the DSS big data environment advisor 105 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a DSS big data environment advisor module 216 that may provide functionality that may include, but is not limited to, configuring a data processing system for analyzing a big data dataset in accordance with some embodiments of the inventive subject matter.

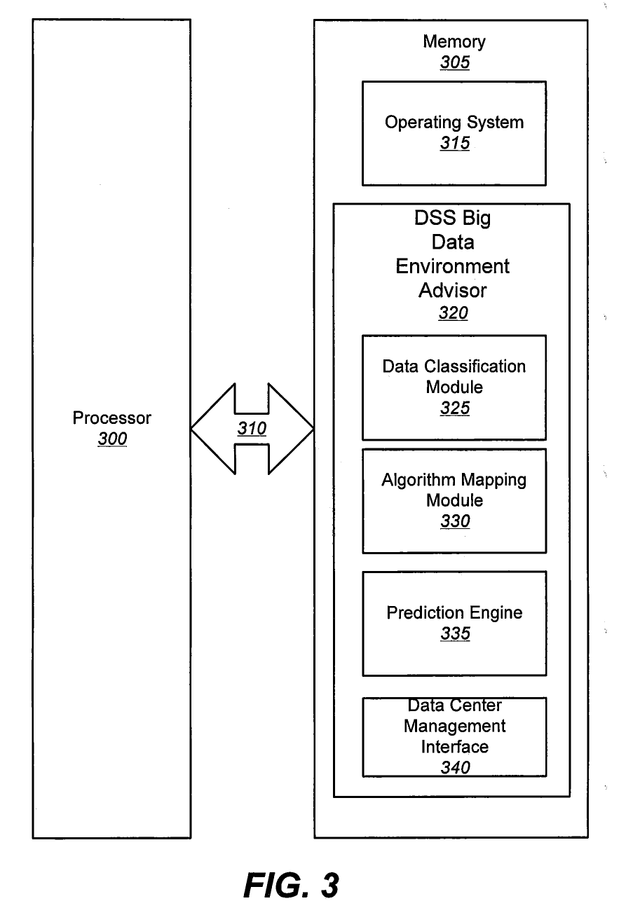

FIG. 3 illustrates a processor 300 and memory 305 that may be used in embodiments of data processing systems, such as the data processing system 200 of FIG. 2, respectively, for configuring a data processing system for analyzing a big data dataset according to some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for configuring a data processing system for analyzing a big data dataset in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain two or more categories of software and/or data: an operating system 315 and a DSS big data environment advisor module 320. In particular, the operating system 315 may manage the data processing system's software and/or hardware resources and may coordinate execution of programs by the processor 300. The DSS big data environment advisor module 320 may comprise a data classification module 325, an algorithm mapping module 330, a prediction engine module 335, and a data center management interface module 340.

The data classification module 325 may be configured to collect metadata corresponding to the analysis jobs performed previously on other big data datasets by various data processing systems and data processing system configurations including the data processing system target for a current active data dataset. The algorithm mapping module 330 may be configured to select a machine learning algorithm form a plurality of machine learning algorithm that may be the most accurate in determining a prediction for the performance of a data processing system in analyzing a current active data dataset. This selection may be made based on one or more previous predictions with respect to various data processing systems and data processing system configurations. The prediction engine module 335 may be configured to generate a prediction of the performance of a data processing system with respect to one or more performance parameters in response to a request identifying the one or more performance parameters and new active data forming part of a big data dataset to be analyzed. The prediction engine module 335 may select a group of historical metadata (i.e., metadata for data that has already been analyzed by one or more data processing systems) that most closely matches the metadata of the new active data to be analyzed from the data classification module 325 and may select a machine learning algorithm that is the most efficient at generating a prediction for the particular performance parameter(s) from the algorithm mapping module 330. The prediction engine module 335 may then apply the particular machine learning algorithm received from the algorithm mapping module 330 to the group of historical metadata to build a prediction model, which may be an equation, graph, or other mechanism for specifying a relationship between the data points in the group of historical metadata. The prediction model may then be applied to the metadata of the new active data to generate a prediction of the level of performance with respect to one or more performance parameters in analyzing the new active data on the data processing system. The data center management interface module 340 may be configured to communicate changes to a configuration of a data processing system based on the prediction generated by the prediction engine module 335. The DSS big data environment advisor data processing system 105 may be integrated as part of a data center management system or may be a stand-alone system that communicates with a data center management system over a network or suitable communication connection.

Although FIG. 3 illustrates hardware/software architectures that may be used in data processing systems, such as the data processing system 200 of FIG. 2 for configuring a data processing system for analyzing a big data dataset according to some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the DSS big data environment advisor data processing system 105, the data processing system 200 of FIG. 2, and hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

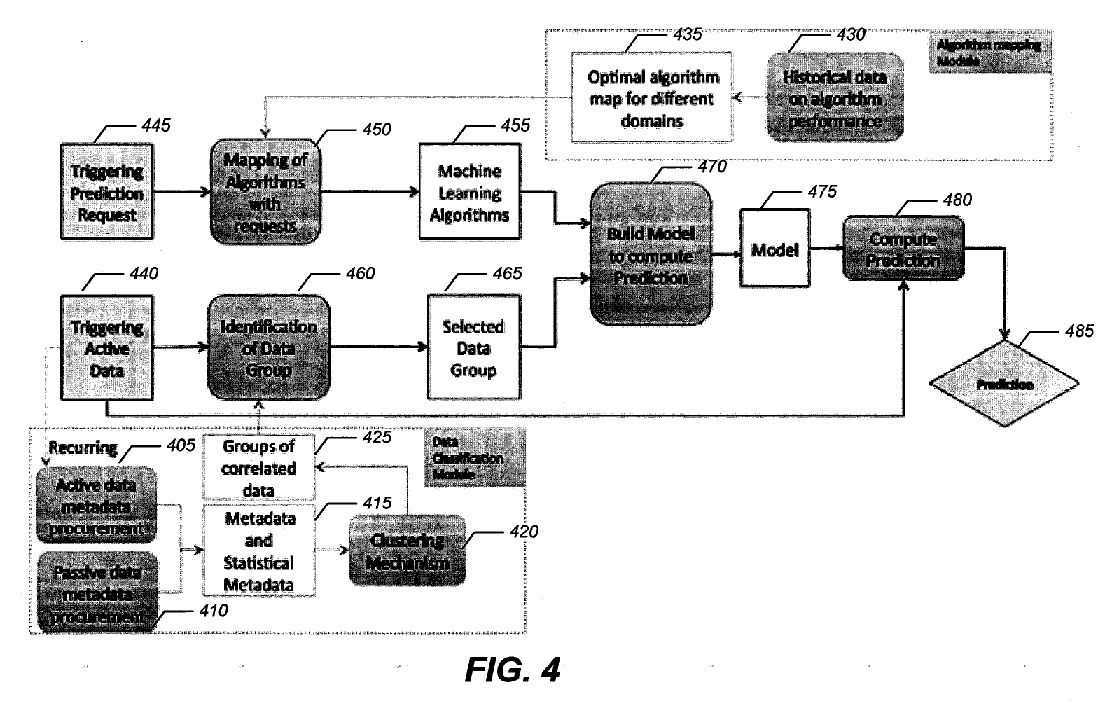

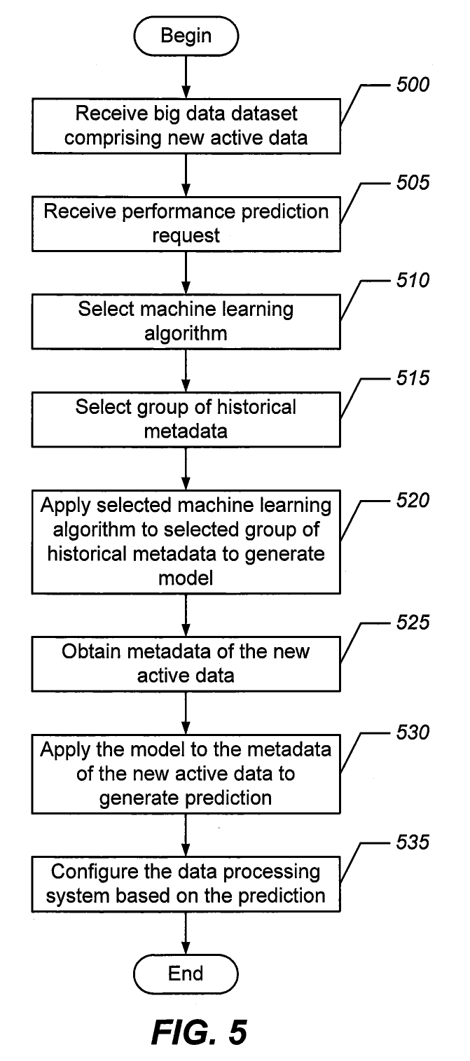

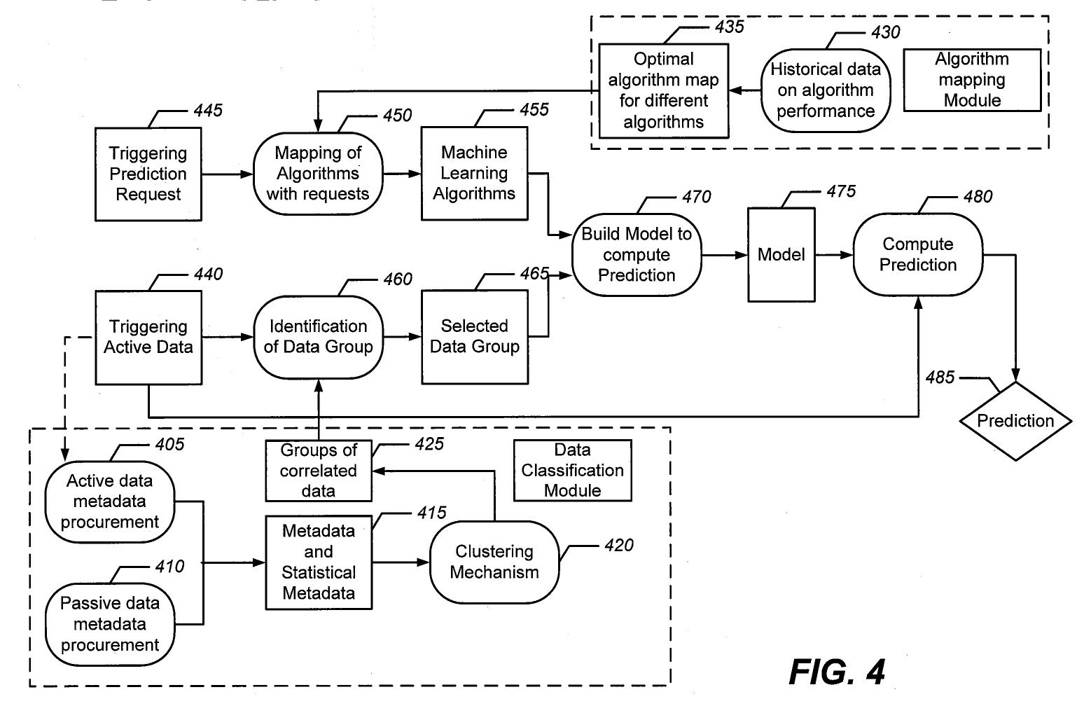

The data processing apparatus of FIGS. 1-3 may be used to determine how to configure a product for localization to a geographic region according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 include computer readable program code that, when executed by the respective processors, causes the respective processors to perform operations including one or more of the operations described herein with respect to FIGS. 4-5.

FIG. 4 is a block diagram that illustrates functional relationships between the modules of FIG. 3. Referring now to FIG. 4, the data classification module 325 provides an active data metadata procurement module 405 and a passive data metadata procurement module 410. The active data metadata procurement module 405 may be configured to obtain metadata for new active data that is received for processing as it is received. The passive data metadata procurement module 410 may be configured to fetch the historical metadata for all datasets that have previously been analyzed using the data processing system, the data processing system as configured differently, and/or other data processing systems. The collected metadata is compiled at block 415 as metadata and statistical metadata. A clustering module 420 may be configured to perform a cluster analysis on the historical metadata of block 415 based on a plurality of attributes to generate groups of historical metadata with similar attribute sets represented as module 425. In accordance with various embodiments of the inventive subject matter, the attributes may include, but are not limited to, an analysis job name, a data processing system name, a time of execution for performing an analysis, an amount of memory used in performing an analysis, type of analysis performed, and an amount of data processed during performing an analysis. The number of groups that are crated for each attribute set is determined by the clustering algorithm used where a new sub-group is formed when there is sufficient amount of similar data. The cardinality of the groups depends on correlation in the historical metadata.

The algorithm mapping module 330 provides a library of possible machine learning algorithms that can be used in generating a model for predicting the performance of a data processing system in the analyzing a big data dataset. Different machine learning algorithms may generate better models than others depending on the particular performance parameter of interest. Thus, the algorithm mapping module 330 may maintain information on the accuracy of the resulting performance predictions when various machine learning algorithms were previously used for various performance parameters. The algorithm mapping module 330 may provide to the prediction engine 335 the machine learning algorithm that has resulted in the most accurate predictions for a particular performance parameter at block 435. The algorithm mapping module 330 may also provide one or more default machine learning algorithms when no historical prediction accuracy data is available for a particular performance parameter. Various machine learning algorithms can be used in accordance with embodiments of the inventive subject matter, including, but not limited to, kernel density estimation, K-means, kernel principal components analysis, linear regression, neighbors, non-negative matrix factorization, support vector machines, dimensionality reduction, fast singular value decomposition, and decision tree.

The remaining blocks of FIG. 4 may comprise components of the prediction engine module 335. A big data dataset comprising new active data may be received at block 440. Before sending the new active data to a data processing system for processing, embodiments of the present invention can be used to generate a prediction of the performance of the data processing system in analyzing the new active data. Thus, a prediction request may be received at block 445 that comprises a request to predict a level of performance of the data processing system with respect to one or more parameters. The performance parameters may include, but are not limited to, a time for execution for performing an analysis, a probability of determining a pattern in the new active data, resources, such as processing, memory, and network used in performing the analysis, and the like in accordance with various embodiments of the inventive subject matter. The prediction engine module 335 communicates with the algorithm mapping module 330 at block 450 to obtain the best machine learning algorithm for the particular performance parameter to be predicted at block 455. The prediction engine module 335 obtains metadata of the new active data at block 460 and communicates with the data classification module 325 to perform a comparison to determine which group of historical metadata most closely resembles the metadata of the new active data. The selected group of historical metadata, which was identified based on the comparison, is output at block 465.

A model or prediction model is generated at block 470 based on the selected machine learning algorithm at block 455 and the selected group of historical metadata at block 465. In accordance with various embodiments of the inventive subject matter, the model may be an equation, graph, or other construct/mechanism for specifying a relationship between the data points in the group of historical metadata. For example, if linear regression is chosen as the machine learning algorithm, an equation may be generated that most fits the data points in the group of historical metadata. The resulting model is output at block 475. The prediction engine module 335 applies the model obtained at block 475 to the metadata of the new active data at block 480 to generate a prediction 485 of the level of performance with respect to the requested performance parameter. For example, if the performance parameter is a time for execution for performing an analysis, the makespan value may be computed by applying the model generated by the machine learning algorithm to the metadata of the new active data of the big data dataset to be analyzed. The prediction 485 can be used to configure the data processing system for analyzing the big data dataset comprising the new active data. For example, various thresholds may be defined for one or more parameters that when compared to the predicted performance level provide an indication that changes need to be made to the data processing system before the big data dataset is provided to the data processing system for analysis to improve the performance of the data processing system.

In some embodiments of the inventive subject matter, to improve the accuracy of the prediction, rather than using a single machine learning algorithm that is considered the most accurate for generating a prediction for a particular performance parameter, an ensemble methodology may be used where multiple machine learning algorithms are applied to the selected group of historical metadata to generate a plurality of models. The plurality of models may then be applied to the metadata of the new active data to generate a plurality of predictions, which can then be processed using an ensemble methodology to provide a final prediction. The ensemble methodology may be used when the models generated by the machine learning algorithms are independent of each other. In accordance with various embodiments of the inventive subject matter, the ensemble methods may include, but are not limited to, Bayes optimal classifier, bagging, boosting, Bayesian parameter averaging, Bayesian model combination, bucket of models, and stacking.

FIG. 5 is a flowchart that illustrates operations for configuring a data processing system for analyzing a big dataset in accordance with some embodiments of the inventive subject matter. Referring to FIG. 5, operations begin at block 500 where the prediction engine module 335 receives a big data dataset comprising new active data along with a performance prediction request at block 505. The performance prediction request is a request to predict a level of performance of the data processing system that will be assigned to analyze bit data dataset comprising the new active data based on one or more performance parameters. The prediction engine module 335 selects a machine learning algorithm at block 510 provided by the algorithm mapping module 330 based on the one or more performance parameters contained in the request. The prediction engine module 335 selects a group of historical metadata at block 5154 from a plurality of groups of historical metadata that have previously been analyzed using the data processing system and/or other data processing systems including the present data processing system configured differently. The selected machine learning algorithm is applied to the selected group of historical metadata at block 520 to generate a model of the selected group of historical metadata. The prediction engine module 335 obtains metadata of the new active data at block 525 and applies the model generated at block 520 to the metadata of the new active data to generate a prediction of the level of performance of the data processing system with respect to the one or more performance parameters at block 530. The configuration of the data processing system may be configured at block 535 based on the prediction of the level of performance of the data processing system with respect to the performance parameter.

Some embodiments of the inventive subject matter may provide a DSS that can assist users of a big data analysis center in configuring their data processing system for a particular big, data analysis task to meet, for example, requirements of service level agreements. Unexpected alerts and breakdowns may be reduced as a data processing system may be better configured to process a big data analysis job before the job starts. As big data is by definition resource intensive in terms of the amount and complexity of the data to be analyzed, even minor improvements in data processing system performance can result in large savings in terms of cost, resource usage, and time. A prediction of the performance of a data processing system, according to embodiments of the inventive subject matter, is generated in a technology agnostic manner and uses ensemble approaches of machine learning, progressive clustering, and online learning. Moreover, the DSS described herein is self-tuning by improving historical metadata group selection used in model generation based on newly arriving metadata corresponding to new big data analysis jobs.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor:
receiving a big data dataset comprising new active data;
receiving a request to predict a level of performance with respect to a performance parameter of a data processing system in analyzing the new active data;
selecting a machine learning algorithm from a plurality of machine learning algorithms based on the performance parameter to obtain a selected machine learning algorithm;
selecting a group of historical metadata from a plurality of groups of historical metadata of datasets that have previously been analyzed using the data processing system to provide a selected group of historical metadata;
applying the selected machine learning algorithm to the selected group of historical metadata to generate a model of the selected group of historical metadata;
obtaining metadata of the new active data;
applying the model to the metadata of the new active data to generate a prediction of the level of performance with respect to the performance parameter; and
configuring the data processing system for analyzing the new active data based on the prediction.

2. The method of claim 1, wherein the data processing system is one of a plurality of data processing systems, wherein the metadata of the new active data and the metadata of the historical metadata correspond to a plurality of attributes; and
wherein selecting the group of historical metadata comprises:
performing a cluster analysis of the metadata of the datasets that have been previously analyzed based on the plurality of attributes;
generating the plurality of groups of historical metadata based on the cluster analysis; and
selecting the group of historical metadata from the plurality of groups of historical metadata based on a comparison of the metadata of the new active data with the plurality of groups of historical metadata.

3. The method of claim 2, wherein the plurality of attributes comprises an analysis job name, a data processing system name, a time of execution for performing an analysis, an amount of memory used in performing an analysis, type of analysis performed, and an amount of data processed during performing an analysis.

4. The method of claim 1, wherein selecting the machine learning algorithm, comprises:
collecting a plurality of previous predictions of the level of performance of the data processing system for a plurality of previous requests to predict the level of performance of the data processing system with respect to a plurality of performance parameters; and
selecting the machine learning algorithm based on the performance parameter and the plurality of previous predictions.

5. The method of claim 4, wherein the performance parameter is one of the plurality of performance parameters; and
wherein the plurality of performance parameters comprises a time of execution for performing an analysis, a probability of determining a pattern in the new active data, and memory resources used in performing an analysis.

6. The method of claim 4, wherein applying the selected machine learning algorithm to the selected group of historical metadata to generate the model of the selected group of historical metadata comprises:
applying a plurality of machine learning algorithms to the selected group of historical metadata to generate a plurality of models, respectively.

7. The method of claim 6, wherein applying the model to the metadata of the new active data to generate the prediction of the level of performance with respect to the performance parameter comprises:
applying the plurality of models to the metadata of the new active data using an ensemble method to generate the prediction.

8. The method of claim 7, wherein the ensemble method comprises one of Bayes optimal classifier, bagging, boosting, Bayesian parameter averaging, Bayesian model combination, bucket of models, and stacking.

9. The method of claim 8, wherein the plurality of machine learning algorithms comprise kernel density estimation, K-means, kernel principal components analysis, linear regression, neighbors, non-negative matrix factorization, support vector machines, dimensionality reduction, fast singular value decomposition, and decision tree.

10. A system, comprising:
a processor; and
a memory coupled to the processor and comprising computer readable program code embodied in the memory that when executed by the processor causes the processor to perform operations comprising:
receiving a big data dataset comprising new active data;
receiving a request to predict a level of performance with respect to a performance parameter of a data processing system in analyzing the new active data;
selecting a machine learning algorithm from a plurality of machine learning algorithms based on the performance parameter to obtain a selected machine learning algorithm;
selecting a group of historical metadata from a plurality of groups of historical metadata of datasets that have previously been analyzed using the data processing system to provide a selected group of historical metadata;
applying the selected machine learning algorithm to the selected group of historical metadata to generate a model of the selected group of historical metadata;
obtaining metadata of the new active data;
applying the model to the metadata of the new active data to generate a prediction of the level of performance with respect to the performance parameter; and
configuring the data processing system for analyzing the new active data based on the prediction.

11. The system of claim 10, wherein the data processing system is one of a plurality of data processing systems, wherein the metadata of the new active data and the metadata of the historical metadata correspond to a plurality of attributes; and
wherein selecting the group of historical metadata comprises:
performing a cluster analysis of the metadata of the datasets that have been previously analyzed based on the plurality of attributes;
generating the plurality of groups of historical metadata based on the cluster analysis; and
selecting the group of historical metadata from the plurality of groups of historical metadata based on a comparison of the metadata of the new active data with the plurality of groups of historical metadata.

12. The system of claim 10, wherein selecting the machine learning algorithm, comprises:
collecting a plurality of previous predictions of the level of performance of the data processing system for a plurality of previous requests to predict the level of performance of the data processing system with respect to a plurality of performance parameters; and
selecting the machine learning algorithm based on the performance parameter and the plurality of previous predictions.

13. The system of claim 12, wherein applying the selected machine learning algorithm to the selected group of historical metadata to generate the model of the selected group of historical metadata comprises:
applying a plurality of machine learning algorithms to the selected group of historical metadata to generate a plurality of models, respectively.

14. The system of claim 13, wherein applying the model to the metadata of the new active data to generate the prediction of the level of performance with respect to the performance parameter comprises:
applying the plurality of models to the metadata of the new active data using an ensemble method to generate the prediction.

15. The system of claim 14, wherein the plurality of machine learning algorithms comprise kernel density estimation, K-means, kernel principal components analysis, linear regression, neighbors, non-negative matrix factorization, support vector machines, dimensionality reduction, fast singular value decomposition, and decision tree.

16. A computer program product, comprising:
a tangible computer readable storage medium comprising computer readable program code embodied in the medium that when executed by a processor causes the processor to perform operations comprising:
receiving a big data dataset comprising new active data;
receiving a request to predict a level of performance with respect to a performance parameter of a data processing system in analyzing the new active data;
selecting a machine learning algorithm from a plurality of machine learning algorithms based on the performance parameter to obtain a selected machine learning algorithm;
selecting a group of historical metadata from a plurality of groups of historical metadata of datasets that have previously been analyzed using the data processing system to provide a selected group of historical metadata;
applying the selected machine learning algorithm to the selected group of historical metadata to generate a model of the selected group of historical metadata;
obtaining metadata of the new active data;
applying the model to the metadata of the new active data to generate a prediction of the level of performance with respect to the performance parameter; and
configuring the data processing system for analyzing the new active data based on the prediction.

17. The system of claim 16, wherein the data processing system is one of a plurality of data processing systems, wherein the metadata of the new active data and the metadata of the historical metadata correspond to a plurality of attributes; and
wherein selecting the group of historical metadata comprises:
performing a cluster analysis of the metadata of the datasets that have been previously analyzed based on the plurality of attributes;
generating the plurality of groups of historical metadata based on the cluster analysis; and
selecting the group of historical metadata from the plurality of groups of historical metadata based on a comparison of the metadata of the new active data with the plurality of groups of historical metadata.

18. The system of claim 16, wherein selecting the machine learning algorithm, comprises:
collecting a plurality of previous predictions of the level of performance of the data processing system for a plurality of previous requests to predict the level of performance of the data processing system with respect to a plurality of performance parameters; and
selecting the machine learning algorithm based on the performance parameter and the plurality of previous predictions.

19. The system of claim 18, wherein applying the selected machine learning algorithm to the selected group of historical metadata to generate the model of the selected group of historical metadata comprises:
applying a plurality of machine learning algorithms to the selected group of historical metadata to generate a plurality of models, respectively.

20. The system of claim 19, wherein applying the model to the metadata of the new active data to generate the prediction of the level of performance with respect to the performance parameter comprises:
applying the plurality of models to the metadata of the new active data using an ensemble method to generate the prediction.
